(19) United States
(12) Patent Application Publication
(10) Pub. No.: US 2009/0024470 A1
(43) Pub. Date: Jan. 22, 2009

(54) VERTICAL CLUSTERING AND ANTI-CLUSTERING OF CATEGORIES IN AD LINK UNITS

(75) Inventors: Jacob L. Mandelson, Pasadena, CA (US); Jerry P. Krikheli, Sherman Oaks, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/781,171

(22) Filed: Jul. 20, 2007

(51) Int. Cl. G06Q 30/00

(52) U.S. Cl. 705/14

(57) ABSTRACT

A technique, method, apparatus, and system to provide related ad link units with vertical clustered or anti-clustered categories to be displayed with web page content for view by a user. In one implementation, a method is provided. The method includes selecting a first ad link category for a first position of an ad link unit. One or more second ad link categories are identified using one or more similarity measures, where at least one second ad link category has one or more similarity measures associated with the first ad link category.

### TECHNICAL FIELD

The subject matter of this patent application is generally related to advertising.

### BACKGROUND

Interactive media (e.g., the Internet) has great potential for the targeting of advertisements (“ads”) to receptive audiences. One form of online advertising is ad syndication, which allows advertisers to extend their marketing reach by distributing ads to additional partners. For example, third party online publishers can place an advertiser's text or image ads on web properties with desirable content to drive online customers to the advertiser's website. An example of such a system is AdSense™ offered by Google, Inc.

Ad syndication can also include related ad link units as one type of ad format. Related ad link units display a list of selectable topics or categories as links. For example, third party online publishers can place one or more related ad link units on a requested web page, where the related ad link units display topics or categories relevant to the content of the requested web page. When a user selects one of the categories of the related ad link unit, the user can be presented with ads in the selected category which are related to the content of the requested web page. Related ad link units can provide ads which are closely targeted to the interests of a user.

Related ad link units can display one or more (e.g., four or five) categories. However, if the categories of a related ad link unit are very similar, a user will likely choose the first category, ignoring the remaining categories on the list. This can reduce the distribution potential of the ads in the remaining categories on the list. If multiple related ad link units are displayed with a web page, a user may have difficulty finding a particular category of interest if the categories are scattered across the multiple related ad link units without regard to the similarity or diversity of the categories.

### SUMMARY

A technique, method, apparatus, and system are described to provide related ad link units with vertical clustered or anti-clustered categories to be displayed with web page content for view by a user. A composite similarity measure between two ad link categories can be determined, where the composite similarity measure is one of a maximum, a minimum, or a combination of separate similarity measures for the verticals of a first ad link category with the verticals of a second ad link category. In general, in one aspect, a method is provided. The method includes selecting a first ad link category for a first position of an ad link unit. One or more second ad link categories are identified using one or more similarity measures, where at least one second ad link category has one or more similarity measures associated with the first ad link category.

Implementations can include one or more of the following features. A third ad link category can be selected for a second position of the ad link unit, where the third ad link category is different from the one or more identified second ad link categories. The ad link unit can be associated with a web page, and the ad link categories can be ordered by relevance to the web page. Identifying one or more second ad link categories using one or more similarity measures can include identifying one or more ad link categories having a similarity measure that is less than a similarity threshold. The ad link categories can be associated with one or more vertical identifiers, and at least one of the one or more similarity measures of a second ad link category can be a measure of the similarity between a vertical identifier associated with the second ad link category and a vertical identifier associated with the first ad link category. At least one second ad link category can have a separate similarity measure for at least one pair-wise combination of a vertical identifier associated with the at least one second ad link category and a vertical identifier associated with the first ad link category. The at least one second ad link category can have a composite similarity measure, where the composite similarity measure can be one of a maximum, a minimum, or a combination of the separate similarity measures for the at least one second ad link category. Identifying one or more ad link categories having a similarity measure that is less than a similarity threshold can include identifying one or more ad link categories having a composite similarity measure that is less than a similarity threshold.

In general, in one aspect, a method is provided. The method includes selecting a first ad link category for a first position of an ad link unit, where the first ad link category is in a set of candidate ad link categories. For at least one empty position in the ad link unit, ad link categories having a similarity measure that is less than a similarity threshold are identified, where the identified ad link categories are in the set of candidate ad link categories, and at least one ad link category in the set of candidate ad link categories has one or more similarity measures associated with a most recently selected ad link category. For at least one empty position in the ad link unit, a next ad link category for a next empty position of the ad link unit is selected, where the next ad link category is in the set of candidate ad link categories.

Implementations can include one or more of the following features. The identified ad link categories can be removed from the set of candidate ad link categories. The selected ad link categories can be removed from the set of candidate ad link categories. The ad link categories in the set of candidate ad link categories can be associated with a web page, and the ad link categories in the set of candidate ad link categories can be ordered by relevance of the ad link categories to the web page.

In general, in one aspect, a method is provided. The method includes, for a set of candidate ad link categories and at least one ad link unit associated with a web page, selecting a first ad link category for a first position of the ad link unit, where the first ad link category is in the set of candidate ad link categories. For at least one empty position in the ad link unit, ad link categories having a similarity measure that is greater than a similarity threshold are identified, where the identified ad link categories are in the set of candidate ad link categories, and at least one ad link category in the set of candidate ad link categories has one or more similarity measures associated with a most recently selected ad link category. For at least one empty position in the ad link unit, a next ad link category is selected for a next empty position of the ad link unit, where the next ad link category is in the set of candidate ad link categories.

Implementations can include the following feature. The identified ad link categories can be removed from the set of candidate ad link categories before selecting a next ad link category for a next empty position of the ad link unit, and at least one removed identified ad link category can be added to the set of candidate ad link categories before selecting a first ad link category for a first position of a next ad link unit.

Other implementations are disclosed, including implementations directed to systems and computer-readable medium.

Particular embodiments of the subject matter described in this specification can be implemented to realize one or more of the following advantages. The quality of related ad link units and user experience can be improved by increasing the variety of categories displayed in a single related ad link unit. When multiple related ad link units are to be displayed, individual related ad link units can include similar categories while sets of categories can be diversified across the multiple related ad link units.

### DESCRIPTION OF DRAWINGS

FIG. 1 is a block diagram of an example online advertising system.

FIG. 2A illustrates an example of a related ad link unit provided with web page content.

FIG. 2B illustrates an example of multiple related ad link units provided with the web page content.

FIG. 3A illustrates an example implementation of a related ad link unit with anti-clustered categories provided with web page content.

FIG. 3B illustrates an example implementation of multiple related ad link units with clustered categories provided with web page content.

FIG. 4 is a block diagram of an example implementation of an advertising management system of FIG. 1 that provides related ad link units with clustered and anti-clustered categories.

FIG. 5 is a block diagram of an example implementation of the ad link server of FIG. 4.

FIG. 6 is a flow diagram of an example process for providing a related ad link unit with anti-clustered categories.

FIG. 7 is a flow diagram of an example process for providing multiple related ad link units with clustered categories.

### DETAILED DESCRIPTION

Techniques, methods, apparatus, and a system for presenting sponsored content (e.g., advertising) are described. In some implementations, the techniques, methods, apparatus and system can be used to facilitate online advertising, being advertising occurring over a network including one or more local area networks (LANs) or a wide area network (WAN), for example, the Internet. Any reference herein to “online advertising” is meant to include any such advertising occurring over a network and is not limited to advertising over the Internet. Further, the techniques and system described can be used to distribute other forms of sponsored content over other distribution media (e.g., not online), including those over broadcast, wireless, radio or other distribution networks. By way of example, the techniques and system are discussed in an online advertising context, but other contexts are possible. For example other forms of content can be delivered other than advertisements.

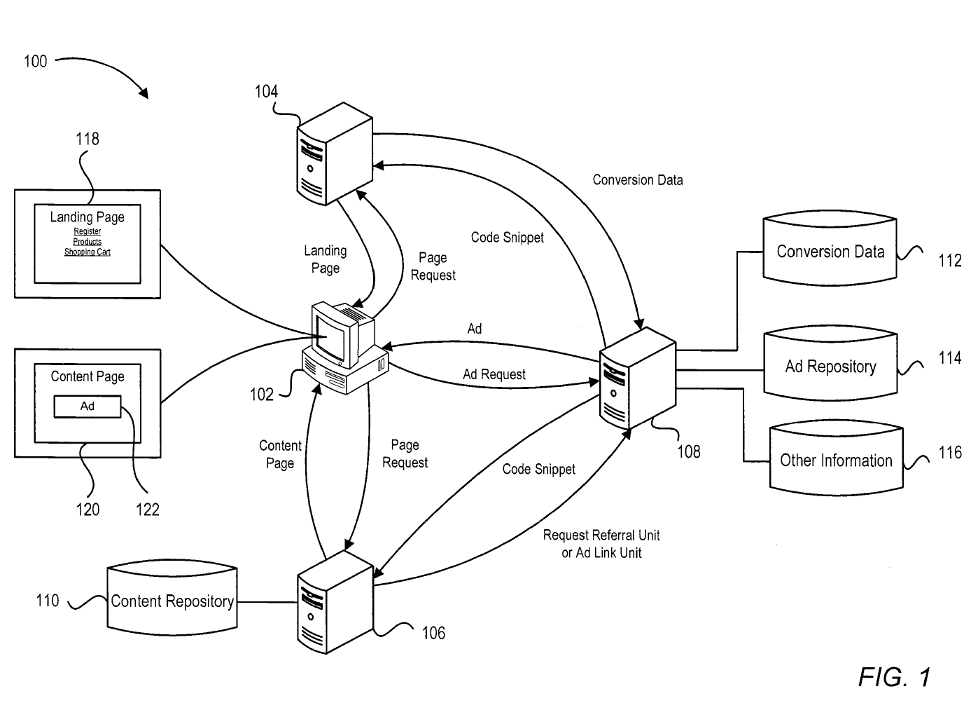

FIG. 1 is a block diagram of an example online advertising system 100. In some implementations, one or more advertisers 104 can directly, or indirectly, enter, maintain, and track advertisement (“ad”) information in an ad management system 108. The ads can be stored in a repository 114 coupled to the system 108 (e.g., a MySQL® database). The ads may be in the form of graphical ads, such as banner ads, text only ads, image ads, audio ads, video ads, ads combining one of more of any of such components, etc. The ads may also include embedded information, such as embedded media, links, meta-information, and/or machine executable instructions. One or more publishers 106 may submit requests for ads or ad link units to the system 108. The system 108 responds by sending ads, ad link units, or information that will allow for the retrieval of ads or ad link units to the requesting publisher 106 for placement/serving on one or more of the publisher's web properties (e.g., websites and other network-distributed content). The ads or ad link units can be placed with or embedded in the publisher's content (e.g., videos, articles, search results), which can be stored in a repository 110 at the publisher 106, and/or placed with content received from other sources (e.g., other publishers, advertisers).

In some implementations, publisher's properties available in this system may also include both Internet-distributed and broadcast distributed content such as, but not limited to, television spots, radio spots, print advertising, billboard advertising (electronic or printed), on-vehicle advertising, and the like.

Other entities, such as users 102 and advertisers 104, can provide usage information to the system 108, such as, for example, whether or not a conversion or click-through related to an ad has occurred. In some implementations, conversion data can be stored in a repository 112, where it can be used by the system 108 to improve ad targeting performance. The usage information provided to the system 108 can include measured or observed user behavior related to ads that have been served. In some implementations, the system 108 performs financial transactions, such as crediting the publishers 106 and charging the advertisers 104 based on the usage information.

A computer network, such as a local area network (LAN), wide area network (WAN), the Internet, wireless network or a combination thereof, can connect the advertisers 104, the system 108, the publishers 106, and the users 102.

One example of a publisher 106 is a general content server that receives requests for content (e.g., articles, electronic mail messages, discussion threads, music, video, graphics, networked games, search results, web page listings, information feeds, dynamic web page content, etc.), and retrieves the requested content in response to the request. The content server may submit a request (either directly or indirectly) for ads or ad link units to an ad server in the system 108. The ad request may include a number of ads desired. The ad link unit request may include a number of ad link units desired and the number of ad links per ad link unit. The ad or ad link unit request may also include content request information. This information can include the content itself (e.g., page or other content document), a category or keyword corresponding to the content or the content request (e.g., arts, business, computers, arts-movies, arts-music, etc.), part or all of the content request, content age, content type (e.g., text, graphics, video, audio, mixed media, etc.), geo-location information, demographic information related to the content, keyword, web property, etc., and the like.

In some implementations, the content server (or a browser rendering content provided by the content server) can combine the requested content with one or more of the ads or ad link units provided by the system 108. The combination can happen prior to delivery of the content to the user or contemporaneously where the advertising server can serve the ads or ad link units directly to an end user. The combined content and ads or ad link units can be delivered to the user 102 that requested the content for presentation in a viewer (e.g., a browser or other content display system). The content server can transmit information about the ads or ad link units back to the ad server, including information describing how, when, and/or where the ads or ad link units are to be rendered (e.g., in HTML or JavaScript™). The content page 120 can be rendered in the user's viewer with one or more ads 122. When the user 102 clicks on a displayed ad 122 of an advertiser, the user 102 can be redirected to a landing page 118 of the advertiser's web site.

In another example, the publisher 106 is a search service. A search service can receive queries for search results. In response, the search service can retrieve relevant search results from an index of content (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of search results (e.g., ten).

The search service can submit a request for ads or ad link units to the system 108. The request may include a number of ads or ad link units desired. An ad link unit request may include a number of ad link units desired and the number of ad links per ad link unit. The number of ads or number of ad link units may depend on the search results, the amount of screen or page space occupied by the search results or other content to be displayed contemporaneously with the sponsored content, the size and shape of the ads, etc. In some implementations, the number of desired ads can be from one to ten, or from three to five. In some implementations, the number of desired ad link units can be greater than one (e.g., three). The request for ads or ad link units may also include a query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. Other information can be included in the request including information related to the content that is to be displayed contemporaneously with the sponsored content. In some implementations, IR scores can be computed from, for example, dot products of feature vectors corresponding to a query and a document, page rank scores, and/or combinations of IR scores and page rank scores, etc.

A search service can combine the search results with one or more of the ads or ad link units provided by the system 108. This combined information can then be forwarded/delivered to the user 102 that requested the content. The search results can be maintained as distinct from the ads or ad link units, so as not to confuse the user between paid advertisements and presumably neutral search results. The search service can transmit information about the ad or ad link unit and when, where, and/or how the ad or ad link unit was to be rendered back to the system 104.

As can be appreciated from the foregoing, the advertising management system 108 can serve publishers 106, such as content servers and search services. The system 108 permits serving of ads targeted to content (e.g., documents, web pages, web blogs, etc.) served by content servers. For example, a network or inter-network may include an ad server serving targeted ads in response to requests from a search service with ad spots for sale. Suppose that the inter-network is the World Wide Web. The search service can be configured to crawl much or all of the content. Some of this content will include ad spots (also referred to as “inventory”) available. In this example, one or more content servers may include one or more documents. Documents may include web pages, email, content, embedded information (e.g., embedded media), meta-information and machine executable instructions, and ad spots available. The ads inserted into ad spots in a document can vary each time the document is served or, alternatively, can have a static association with a given document.

In one implementation, for the system 104 to provide advertisements to the publisher that are targeted to the user 108 upon whose browser the advertisements will be displayed, it is advantageous for user profile information about the user 108 to be provided to the system 104. In some implementations, user profile information and other types of data can be collected by the system 108 and stored in a repository 116. The stored data may include, for example, geographic locations of users, ad context information, etc. The system can then select the advertisements to provide for viewing by the user 108 based at least in part on the user profile information.

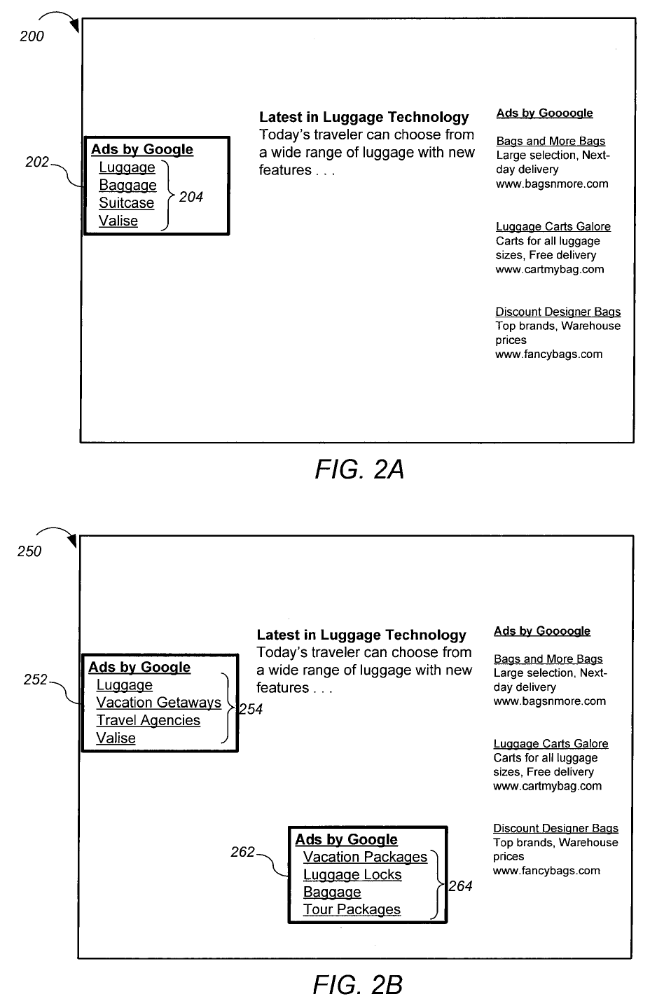

FIG. 2A illustrates an example 200 of a related ad link unit 202 provided with web page content. In example 200, the content of the web page is directed to the latest in luggage technology. The content of the web page is displayed with related ads and the related ad link unit 202.

The related ad link unit 202 includes a list of selectable topics or categories 204 related to the content of the web page. The related ad link unit 202 can present multiple (e.g., four) ad links. In some implementations, the related ad link unit 202 also includes a label (e.g., “Ads by Google”) identifying the link unit 202 as advertisement.

Example 200 includes one related ad link unit 202 for the web page. The related ad link unit includes the following selectable categories 204: luggage, baggage, suitcase, and valise. These categories 204 are related to the content of the web page. However, the categories 204 in the list are very similar to one another. In particular, these categories 204 are synonyms of each other. A user presented with the luggage technology web page content and the related ad link unit 202 is likely to find little variety in the listed categories 204. If the user decides to select any category, the user is likely to select the first category, (e.g., luggage) and ignore the other three categories because of their high similarity to the first category.

Despite the similarity in the categories 204, the list of ads presented when one category is selected may differ from the list of ads presented when another category is selected. The ads associated with the similar categories that are lower on the related ad link unit list are at a disadvantage relative to the ads associated with the first category in the list.

FIG. 2B illustrates an example 250 of multiple related ad link units 252, 262 provided with web page content. As with example 200 of FIG. 2A, the content of the web page is directed to the latest in luggage technology.

Example 250 includes two related ad link units 252, 262 for the web page. The related ad link unit 252 includes the following selectable categories 254: luggage, vacation getaways, travel agencies, and valise. The related ad link unit 262 includes the following selectable categories 264: vacation packages, luggage locks, baggage, and tour packages. The categories 254, 264 are related to the content of the web page. However, the categories are scattered across the two related ad link units 252, 262 without regard to the similarity or diversity of the categories. For example, the luggage category of related ad link unit 252 is a synonym of the baggage category of related ad link unit 262. The vacation getaways category of related ad link unit 252 is a synonym of the vacation packages category of related ad link unit 262. Additionally, the categories within each link unit are diverse. For example, vacation packages and luggage locks are disparate categories in the related ad link unit 262. If the categories are incoherently assembled in multiple related ad link units without considering similarity or diversity, a user may have difficulty finding a particular category of interest.

A technique, method, apparatus, and system are described to provide related ad link units with clustered (e.g., similar) or anti-clustered (e.g., diverse) categories to be displayed with web page content for view by a user. The determination whether to cluster or anti-cluster can be based on, for example, the number of related ad link units to be displayed with web page content. Clustering and anti-clustering can be relative to a vertical classification of the related ad link categories. Verticals can represent industries or broad topics at a high level of a taxonomy system which includes concepts, themes, or categories. Some examples of verticals are travel, entertainment, office supplies, and education. Related ad link categories can be ordered in this hierarchy of verticals. In other words, related ad link categories can be classified according to one or more verticals. For example, “Hawaiian travel” can be categorized under both a Hawaii vertical and a travel vertical. The related ad link category “luggage” can fall into a vertical for containers for travel.

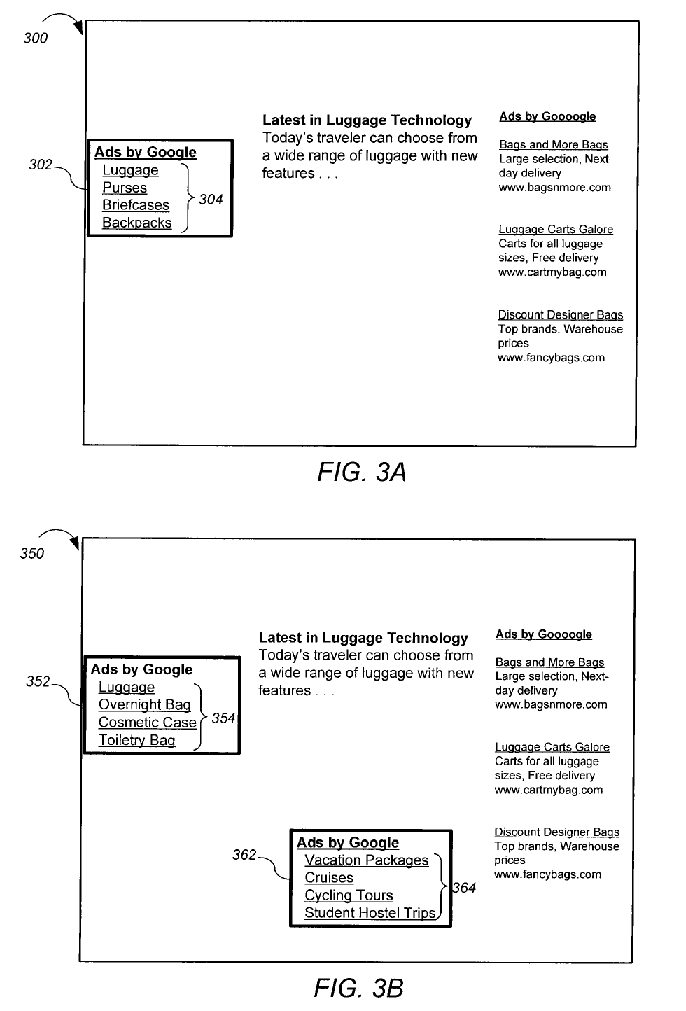

FIG. 3A illustrates an example implementation 300 of a related ad link unit 302 with anti-clustered categories 304 provided with web page content. As with the example 200 of FIG. 2A, the content of the web page is directed to the latest in luggage technology. However, in the example implementation 300, the listed categories 304 are not limited to the containers for travel vertical, and the listed categories 304 are not synonyms of each other. Instead, the related ad link unit 302 provides varied categories 304 (e.g., luggage, purses, briefcases, and backpacks) which are related to the content of the web page. The varied categories 304 fall into a number of verticals including, for example, accessories, office supplies, and education supplies. The categories 304 are anti-clustered by verticals to provide a diversity of ad topics for the user. The technique of anti-clustering is described in more detail below. User experience can be improved by presenting the varied categories 304 within the single related ad link unit 302, allowing the user to better distinguish between available ad topics.

FIG. 3B illustrates an example implementation 350 of multiple related ad link units 352, 362 with clustered categories 354, 364 provided with web page content. The link unit 352 includes the following selectable categories 354: luggage, overnight bag, cosmetic case, and toiletry bag. The link unit 362 includes the following selectable categories 364: vacation packages, cruises, cycling tours, and student hostel trips. The categories 354, 364 are related to the content of the web page and are assembled such that the categories in one related ad link unit are chosen from the same vertical or similar verticals (e.g., clustered) while the categories in the other related ad link unit are chosen from diverse verticals (e.g., anti-clustered). That is, the categories 354 of related ad link unit 352 are all containers for travel while the categories 364 of related ad link unit 362 are all types of travel. Assembling related ad link categories in multiple related ad link units by similar or diverse verticals brings coherency to the presentation of the related ad link units, allowing a user to better distinguish between available ad topics and to more easily find a particular category of interest.

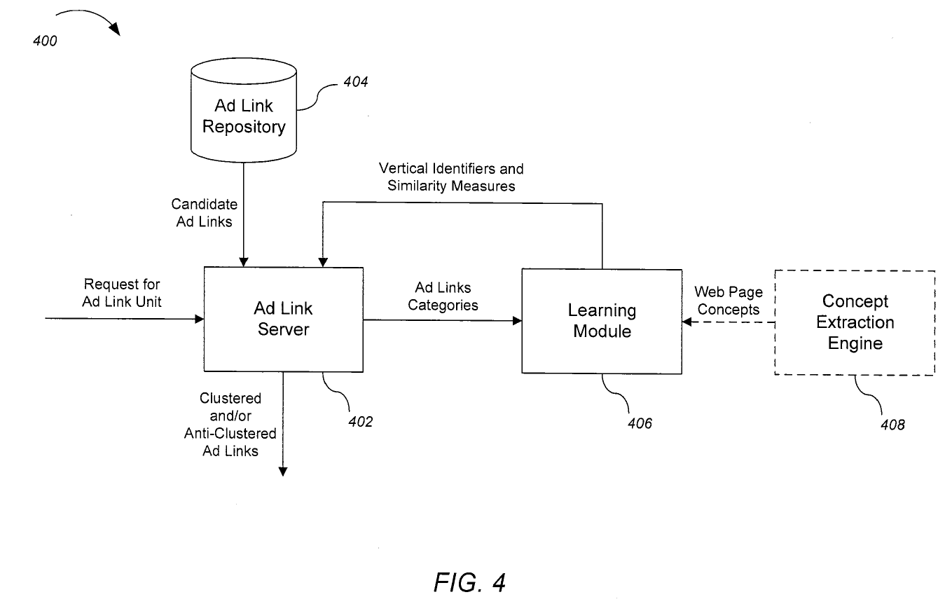

FIG. 4 is a block diagram of an example implementation 400 of an advertising management system 108 of FIG. 1 that provides related ad link units with clustered and anti-clustered categories. The advertising management system 108 includes an ad link server 402, an ad link repository 404, and a learning module 406. In some implementations, the system 108 also includes a concept extraction engine 408. In some implementations, the ad server in system 108 also serves related ad links.

The ad link server 402 receives requests for related ad link units. In some implementations, the ad link server 402 receives related ad link unit requests from one or more content servers. An ad link unit request can accompany an ad request, where both the ad and ad link unit are to be displayed with the same content. In some implementations, a content server sends a combined request for both ads and ad link units. The related ad link unit request may include a number (e.g., one, two, or three) of related ad link units desired and the number (e.g., four or five) of related ad link unit categories for each related ad link unit. The related ad link unit request may also include content request information. For example, the information can include the content itself or one or more categories or keywords corresponding to the content or the content request.

The ad link server 402 receives candidate related ad links from an ad link repository 404. In some implementations, the candidate related ad links are determined based on keywords corresponding to the requested content with which the related ad link unit is to be displayed. Other matching techniques can be used.

The ad link server 402 identifies categories for the candidate related ad links and forwards the categories to a learning module 406. In some implementations, the categories are the same as the candidate related ad links. In some implementations, the candidate related ad links are a subset of the categories that can be selected for ad link units displayed with requested content.

In some implementations, the related ad link unit request can include an identifier (e.g., the Uniform Resource Locator (URL)) of the webpage with the requested content with which the related ad link unit is to be displayed. Using the identifier, the web page can be crawled to determine one or more concepts evoked by the content of the web page. An optional concept extraction engine 408 can extract concepts from the web page content. The web page concepts can be forwarded to the learning module 406. Some examples of concept extraction engines are described in U.S. Pat. No. 7,231,393, filed Feb. 26, 2004, for “Method and Apparatus for Learning a Probabilistic Generative Model for Text,” Attorney Docket No. GGL-071-01-US and U.S. Patent Publication No. 2004/0068697 A1, filed Sep. 30, 2003, for “Method and Apparatus for Characterizing Documents Based on Clusters of Related Words,” Attorney Docket No. GGL-071-00-US, each of which is incorporated by reference herein in its entirety.

The learning module 406 receives related ad link categories from the ad link server 402. The learning module 406 generates or retrieves one or more vertical identifiers associated with each related ad link category. As described above, each related ad link category can be classified under one or more verticals. In some implementations, the vertical identifiers are predetermined. For example, the vertical identifiers for the related ad link categories can be determined before a related ad link unit request is served. In some implementations, the vertical identifiers are pre-computed for the keywords for ads in the ad link repository 404.

In some implementations, the learning module 406 also receives web page concepts from the concept extraction engine 408. Web page concepts can also be classified under one or more verticals. Vertical identifiers for the web page concepts can be determined when a related ad link unit request is received.

The learning module 406 computes one or more similarity measures for each related ad link category. A similarity measure provides a measure of how “close” or “distant” in similarity two vertical identifiers are, where the pair of vertical identifiers corresponds to two related ad link categories. If vertical identifiers are determined for the web page concepts, similarity measures can also be computed between a vertical identifier associated with a related ad link category and a vertical identifier associated with one of the web page concepts.

In some implementations, the similarity measure can be computed using statistics accumulated over a large set of documents (e.g., web pages). For example, the number of instances of a document evoking two vertical concepts can be determined. The number of instances can be used as a heuristic to measure the similarity between the two verticals. That is, the larger the number of instances, the more likely the two verticals are similar. Techniques for associating documents and co-occurring vertical concepts are described in U.S. Patent Publication No. 2006/0242013 A1, filed Oct. 26, 2006, for “Suggesting Targeting Information for Ads, Such as Websites and/or Categories of Websites for Example,” Attorney Docket No. GP-497-00-US, which published patent application is incorporated by reference herein in its entirety. The similarity measure is further discussed below.

The ad link server 402 receives from the learning module 406 one or more similarity measures for each related ad link category. In some implementations, the ad link server 402 also receives the vertical identifiers from the learning module 406. The ad link server 402 generates clustered or anti-clustered ad link categories based on the similarity measures of the candidate ad link categories. The clustered or anti-clustered ad link categories are organized into one or more related ad link units which can be provided by the system 108 to the content server to be combined with the requested content.

In some implementations, the ad link server 402 provides the functionality of the learning module 406, including generation or retrieval of the vertical identifiers and the similarity measures. In these implementations, the learning module 406 is not part of system 108.

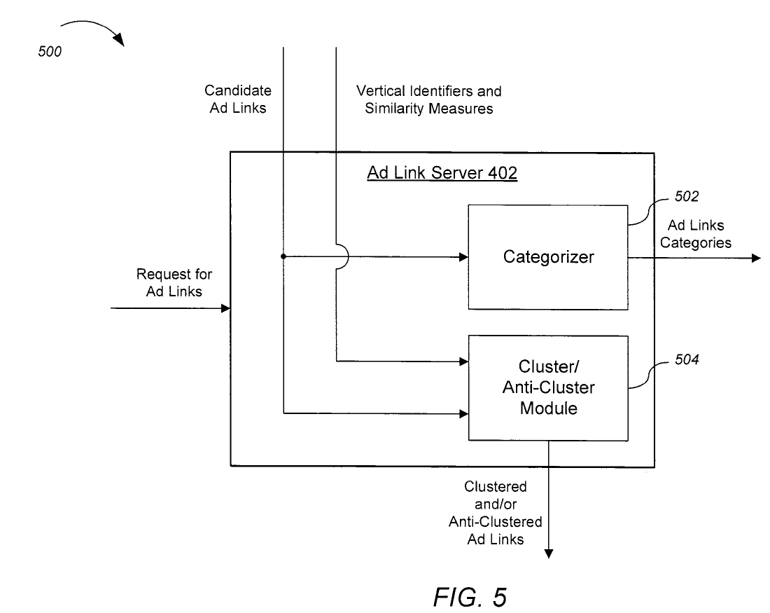

FIG. 5 is a block diagram of an example implementation 500 of the ad link server 402 of FIG. 4. The ad link server 402 includes a categorizer 502 and a cluster/anti-cluster module 504.

The ad link server 402 receives requests for related ad link units. The related ad link unit request may include a number of related ad link units desired and the number of related ad link categories per related ad link unit. The number of related ad link units desired can be used to determine whether related ad link categories should be clustered or anti-clustered.

The ad link server 402 receives candidate related ad links. In some implementations, the candidate related ad links are ordered by relevance to the requested content. The ad link server 402 can receive the ordered list of candidate ad links. Alternatively, the ad link server 402 can receive an unordered list, and the ad link server 402 can order the candidate ad links by relevance to the requested content using a relevance measure.

The categorizer 502 of the ad link server 402 identifies categories for the candidate related ad links. In some implementations, the categories are the same as the related ad links, and the categorizer 502 is not included in the ad link server 402.

The ad link server 402 receives one or more similarity measures for each category. In some implementations, the ad link server 402 also receives the one or more vertical identifiers associated with each category. In some implementations, vertical identifiers are also received for the web page concepts and are used to cluster or anti-cluster ad link categories.

The candidate ad links and the similarity measures are provided as inputs to the cluster/anti-cluster module 504. If the request is for a single related ad link unit, the classification of the categories by verticals is used to improve the diversity of verticals coverage (anti-clustering) of the related ad link categories displayed in the single related ad link unit. If the request is for multiple related ad link units, the classification of the related ad link categories by verticals is used to cluster related ad link categories in one related ad link unit in the same vertical or similar verticals while those in other related ad link units are from different verticals.

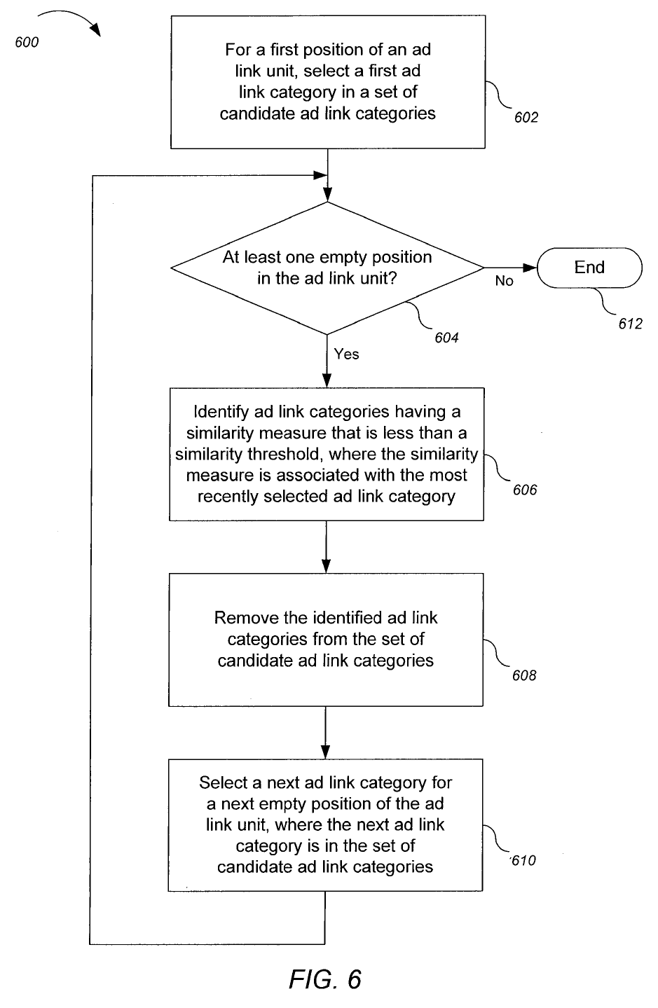

FIG. 6 is a flow diagram of an example process 600 for providing a related ad link unit with anti-clustered categories. The process 600 begins by selecting a first ad link category for a first position of the ad link unit, where the first ad link category is in a set of candidate ad link categories (602). In some implementations, the set of candidate ad link categories is ordered according to the relevance of the ad link categories to the requested content of the web page with which the related ad link unit is to be displayed. For an ordered set of candidate ad link categories, the top relevance scoring ad link category is selected for the first position of the ad link unit. In some implementations, selected ad link categories are removed from the set of candidate ad link categories.

As an example, the set of candidate ad link categories can be ordered by relevance to the requested content of a web page. For a set with the following order: A, B, C, D, . . . , L, category A can be chosen as the most relevant ad link category for the first position of the ad link unit.

The process 600 determines whether there is at least one empty (e.g., unfilled) position remaining in the related ad link unit (604). In some implementations, the link unit request can include the number of ad link categories desired for the related ad link unit. If there are a predetermined number (e.g., zero) of empty positions remaining in the related ad link unit, the process 600 ends (612). Generally, a related ad link unit is displayed with multiple ad link categories.

If there is at least one empty position remaining in the related ad link unit, ad link categories having a similarity measure that is less than a similarity threshold are identified, where the identified ad link categories have one or more similarity measures associated with the most recently selected ad link category (606). The identified ad link categories are in the set of candidate ad link categories. In some implementations, the similarity threshold can be predetermined.

In some implementations the similarity measure can indicate the “distance” between the vertical identifiers of two ad link categories. That is, the smaller the similarity measure, the smaller the “distance” between the vertical identifiers, and the more similar the vertical identifiers are. For this type of similarity measure, the larger the similarity measure, the less similar the vertical identifiers are. Identifying categories that have similarity measures that are less than a similarity threshold means identifying the categories with a vertical identifier that is close (within the similarity threshold) to a vertical identifier of the most recently selected category.

Alternatively, in some implementations, the similarity measure can indicate the “closeness” of the vertical identifiers of two ad link categories. That is, the larger the similarity measure, the more similar the vertical identifiers are. For this type of similarity measure, the process 600 would identify the categories having a similarity measure that is greater than a similarity threshold.

Continuing the example, if the requested ad link unit has three positions and only the first position is filled (by category A), the ad link categories having a similarity measure that is less than a similarity threshold are identified, where the similarity measure is a measure of how “distant” the identified category is to category A. For example, the categories B, C, E, F, and H can be identified as being too close to category A if one of the similarity measures (associated with category A) of each of these categories is found to be less than the similarity threshold.

In some implementations, a given ad link category in the set of candidate ad link categories can have a separate similarity measure for at least one pair-wise combination of a vertical identifier of the given ad link category and a vertical identifier of the most recently selected ad link category. If a given ad link category in the set of candidate ad link categories has multiple similarity measures associated with the most recently selected ad link category, a composite similarity measure can be determined for the given ad link category. The composite similarity measure can be a maximum, a minimum, or a combination (e.g., a weighted combination) of the separate similarity measures for the given ad link category. In these implementations, the candidate ad link categories which are too close to previously selected ad link categories can be identified by comparing the composite similarity measures of the candidate categories to the similarity threshold.

Consider the case, in the above example, where each ad link category (A through L) has two vertical identifiers. Category B has a separate similarity measure for each pair-wise combination of one of category B's two vertical identifiers (VI_{B1} and VI_{B2}) and one of category A's two vertical identifiers (VI_{A1} and VI_{A2}). That is, category B has four separate similarity measures (SM_{B1,A1}, SM_{B1,A2}, SM_{B2,A1}, and SM_{B2,A2}), where SM_{Bi,Aj} is the separate similarity measure for the pair-wise combination of category B's vertical identifier VI_{Bi} and category A's vertical identifier VI_{Aj}. A composite similarity measure CSM_{B,A} can be determined for category B by taking the maximum, the minimum, or a combination of the separate similarity measures SM_{B1,A1}, SM_{B1,A2}, SM_{B2,A1}, and SM_{B2,A2}. To find the similarity measure that indicates the most similar vertical identifiers when the similarity measure represents “distance,” the composite similarity measure CSM_{B,A} can be set to the minimum of the similarity measures. That is, CSM_{B,A}=min_{i,j}{SM_{Bi,Aj}}. A composite similarity measure can be computed for each ad link category in the set of candidate ad link categories (e.g., categories B through L) with multiple similarity measures associated with category A.

Alternatively, to find the similarity measure that indicates the most similar vertical identifiers when the similarity measure represents “closeness,” the composite similarity measure CSM_{B,A} can be set to the maximum of the similarity measures. That is, CSM_{B,A}=max_{i,j}{SM_{Bi,Aj}}. For this type of composite similarity measure, the process 600 would identify the categories having a composite similarity measure that is greater than a similarity threshold.

In the example described above, the categories B, C, E, F, and H are identified as being too close to category A. These candidate categories can be identified by comparing the composite similarity measures with the similarity threshold. In this example, CSM_{B,A}, CSM_{C,A}, CSM_{E,A}, CSM_{F,A}, and CSM_{H,A} are less than the similarity threshold, where the separate similarity measures represent “distance.”

Ad link categories which are identified are removed from the set of candidate ad link categories (608). That is, ad link categories that are too similar to the most recently selected ad link category are eliminated from further consideration based on the similarity measures.

In the above example, identified categories B, C, E, F, and H are removed from the set of candidate ad link categories as being too close in similarity to category A. After the identified categories are removed, the set of candidate ad link categories includes categories D, G, I, J, K, and L.

A next ad link category is selected for the next empty (e.g., unfilled) position of the ad link unit, where the next ad link category is selected from the set of candidate ad link categories (610). For an ordered set of candidate ad link categories, the next most relevant ad link category remaining in the set is selected for the next position of the ad link unit.

Continuing the example, category D is selected to fill the next (e.g., second) position of the ad link unit. Category D is selected, because category D has the highest relevance score of the remaining categories in the set of candidate ad link categories. After category D is selected, the set of candidate ad link categories includes categories G, I, J, K, and L.

In some implementations, when the set of candidate ad link categories is ordered according to relevance, the similarity measures for a particular ad link category are not compared to the similarity threshold unless the preceding ad link categories in the ordered set have already been selected or eliminated. That is, after the first most relevant ad link category is selected, the second ad link category in the ordered set is selected if the second ad link category is not too similar to the first ad link category. If the second ad link category is too similar, the next ad link category in the ordered set is checked for similarity. The process continues until the ad link positions of the ad link unit are filled. Referring to the above example where category A is selected for the first position and categories B and C are eliminated due to similarity to category A, category D is checked for similarity and selected to fill the next (e.g., second) position of the ad link unit. Categories E through L are not checked for closeness to category A.

If there is at least one empty position remaining in the related ad link unit (604), the process repeats steps 606 through 610. The elimination and selection process repeats until a number (e.g., all) of the ad link positions for the related ad link unit have been filled. If the number (e.g., all) of the positions of the related ad link unit have been filled, the process 600 ends (612).

In the above example, only two of the three ad link positions have been filled, so the elimination and selection process repeats for the remaining empty ad link position. Categories G, I, and J can be identified as being too close in similarity to category D (e.g., the most recently selected ad link category) by comparing the composite similarity measure (associated with category D) of these categories to the similarity threshold. The identified categories G, I, and J are eliminated from the set of candidate ad link categories, and the set then includes categories K and L. Category K is selected to fill the third and final ad link position of the related ad link unit.

In some implementations, similarity measures of ad link categories can be used to reorder the set of candidate ad link categories. That is, instead of or in addition to using the similarity measures to eliminate ad link categories, similarity measures can be used to boost or lower the order position of an ad link category in the ordered set of candidate ad link categories. For example, the boosting or lowering can be based on the similarity measure of an ad link category relative to the similarity measures of other ad link categories. In this implementation, the ordering of the set of candidate ad link categories can account for both relevance to requested content and similarity to previously selected ad link categories.

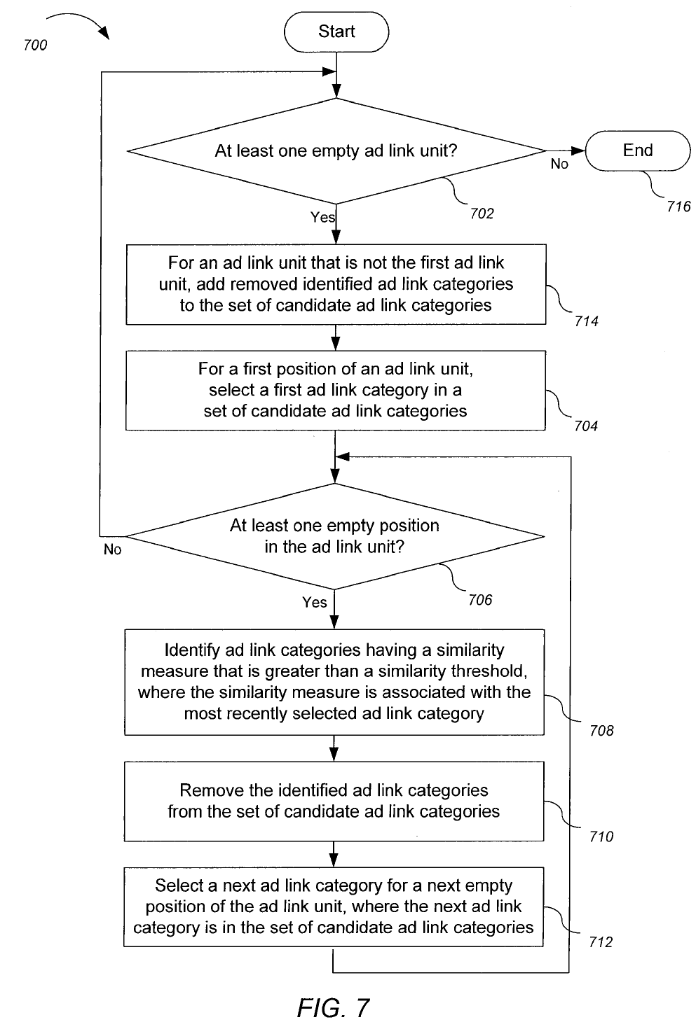

FIG. 7 is a flow diagram of an example process 700 for providing multiple related ad link units with clustered categories. The process 700 begins by determining whether there is at least one empty (e.g., unfilled) related ad link unit (702). In some implementations, the related ad link unit request can include the number of related ad link units desired. If there are a predetermined number (e.g., zero) of empty related ad link units remaining, the process 700 ends (716).

At the start of the process 700, the requested ad link units have not been filled, so the process 700 continues to the next step to fill the first requested ad link unit. A first ad link category is selected for a first position of the ad link unit, where the first ad link category is in a set of candidate ad link categories (704). In some implementations, the set of candidate ad link categories is ordered according to the relevance of the ad link categories to the requested content of the web page with which the related ad link units are to be displayed. For an ordered set of candidate ad link categories, the top relevance scoring ad link category is selected for the first position of the first ad link unit.

As a second example, the ordered set can have the following order: A, B, C, D, . . . , L. Category A can be chosen as the most relevant ad link category for the first position of the first ad link unit.

The process 700 determines whether there is at least one empty (e.g., unfilled) position remaining in the related ad link unit (706). In some implementations, the related ad link unit request can include the number of ad link categories desired for each related ad link unit.

If there is at least one empty position remaining in the related ad link unit, ad link categories having a similarity measure that is greater than a similarity threshold are identified, where at least one identified ad link category has one or more similarity measures associated with the most recently selected ad link category (708). The identified ad link categories are in the set of candidate ad link categories. In some implementations, the similarity threshold can be predetermined. Because the ad link categories within an ad link unit are being clustered, the ad link categories with similarity measures which are greater than the similarity threshold are identified. That is, for a similarity measure that indicates “distance,” the ad link categories with a similarity measure greater than the similarity threshold are the categories that are too diverse to be clustered with the most recently selected ad link category.

Alternatively, in some implementations, the similarity measure can indicate the “closeness” of the vertical identifiers of two ad link categories. For this type of similarity measure, the process 700 would identify the categories having a similarity measure that is less than a similarity threshold.

In some implementations, a given ad link category in the set of candidate ad link categories can have a separate similarity measure for at least one pair-wise combination of a vertical identifier of the given ad link category and a vertical identifier of the most recently selected ad link category. A composite similarity measure can be determined for the given ad link category, for example, by taking a maximum, a minimum, or a combination (e.g., a weighted combination) of the separate similarity measures for the given ad link category. In these implementations, the ad link categories which are too diverse can be identified by comparing the composite similarity measures to the similarity threshold.

Continuing the second example, if the first ad link unit has three positions and only the first position is filled (by category A), the ad link categories having a composite similarity measure that is greater than a similarity threshold are identified, where the similarity measure is a measure of how “distant” the identified category is to category A. For example, the categories D, G, I, J, and K can be identified as being too diverse relative to category A if the composite similarity measure (associated with category A) of these categories is found to be greater than the similarity threshold.

Ad link categories which are identified are removed from the set of candidate ad link categories (710). That is, ad link categories that are too diverse relative to the most recently selected ad link category are eliminated from further consideration based on the similarity measures.

In the above second example, identified categories D, G, I, J, and K are removed from the set of candidate ad link categories as being too diverse relative to category A. After the identified categories are removed, the set of candidate ad link categories includes categories B, C, E, F, H, and L.

A next ad link category is selected for the next empty (e.g., unfilled) position of the ad link unit, where the next ad link category is selected from the set of candidate ad link categories (712). For an ordered set of candidate ad link categories, the next most relevant ad link category remaining in the set is selected for the next position of the ad link unit.

Continuing the second example, category B is selected to fill the next (e.g., second) position of the first ad link unit. Category B is selected, because category B has the highest relevance score of the remaining categories in the set of candidate ad link categories. After category B is selected, the set of candidate ad link categories includes categories C, E, F, H, and L.

In some implementations, when the set of candidate ad link categories is ordered according to relevance, the similarity measures for a particular ad link category are not compared to the similarity threshold unless the preceding ad link categories in the ordered set have already been selected or eliminated. Referring to the second example where category A is selected for the first position, category B is checked for similarity and selected to fill the next (e.g., second) position of the ad link unit. Categories C through L are not checked for closeness to category A.

If there is at least one empty position remaining in the related ad link unit (706), the process repeats steps 708 through 712. The elimination and selection process repeats until a number (e.g., all) of the ad link positions for the related ad link unit have been filled.

In the above second example, only two of the three ad link positions have been filled, so the elimination and selection process repeats for the remaining empty ad link position. In this example iteration, none of the categories are identified as being too distant relative to category B (e.g., the most recently selected ad link category), so none of the categories are eliminated from the set of candidate ad link categories. The set still includes categories C, E, F, H, and L. Category C is selected to fill the third and final ad link position of the first related ad link unit. The set of candidate ad link categories then consists of categories E, F, H, and L.

If a number (e.g., all) of the positions of the related ad link unit have been filled, the process 700 returns to step 702. Again, the process 700 determines whether there is at least one empty (e.g., unfilled) related ad link unit remaining (702).

Consider the case, in the second example, where two related ad link units are requested. Because only the first related ad link unit has been filled, the process 700 repeats for the second requested ad link unit.

Before continuing to step 704, the process 700 adds a number (e.g., all) of the removed identified ad link categories to the set of candidate ad link categories (714). This step is not performed for the first ad link unit, because before the first ad link position is filled in the first ad link unit, ad link categories have not been removed from the set of candidate ad link categories. For later ad link units, previously removed ad link categories are added back to the set of candidate ad link categories because, although these categories were too dissimilar to be included in the cluster for the first ad link unit, the ad link categories for the other ad link units are chosen to be diverse relative to the ad link categories selected for the first ad link unit.

Referring to the second example, the ad link categories D, G, I, J, and K which were previously removed during the filling of the first ad link unit are added back to the set of candidate ad link categories. That is, the set of candidate ad link categories then includes categories E, F, H, and L (which had not been removed) and the added categories D, G, I, J, and K.

The process 700 repeats steps 704 through 714 until there are a predetermined number (e.g., zero) of remaining empty ad link units to be filled. If there are a predetermined number (e.g., zero) of empty ad link units remaining, the process 700 ends (716).

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
selecting a first ad link category for a first position of an ad link unit; and
identifying one or more second ad link categories using one or more similarity measures, at least one second ad link category having one or more similarity measures associated with the first ad link category.

2. The method of claim 1, further comprising:
selecting a third ad link category for a second position of the ad link unit, where the third ad link category is different from the one or more identified second ad link categories.

3. The method of claim 1, wherein:
the ad link unit is associated with a web page; and
the ad link categories are ordered by relevance to the web page.

4. The method of claim 1, wherein identifying one or more second ad link categories using one or more similarity measures further comprises:
identifying one or more ad link categories having a similarity measure that is less than a similarity threshold.

5. The method of claim 4, wherein:
the ad link categories are associated with one or more vertical identifiers; and
at least one of the one or more similarity measures of a second ad link category is a measure of the similarity between a vertical identifier associated with the second ad link category and a vertical identifier associated with the first ad link category.

6. The method of claim 5, wherein at least one second ad link category has a separate similarity measure for at least one pair-wise combination of a vertical identifier associated with the at least one second ad link category and a vertical identifier associated with the first ad link category.

7. The method of claim 6, wherein the at least one second ad link category has a composite similarity measure, the composite similarity measure being one of a maximum, a minimum, or a combination of the separate similarity measures for the at least one second ad link category.

8. The method of claim 7, wherein identifying one or more ad link categories having a similarity measure that is less than a similarity threshold further comprises:
identifying one or more ad link categories having a composite similarity measure that is less than a similarity threshold.

9. A method comprising:
selecting a first ad link category for a first position of an ad link unit, the first ad link category being in a set of candidate ad link categories; and
for at least one empty position in the ad link unit:
identifying ad link categories having a similarity measure that is less than a similarity threshold, the identified ad link categories being in the set of candidate ad link categories, at least one ad link category in the set of candidate ad link categories having one or more similarity measures associated with a most recently selected ad link category; and
selecting a next ad link category for a next empty position of the ad link unit, the next ad link category being in the set of candidate ad link categories.

10. The method of claim 9, further comprising:
removing the identified ad link categories from the set of candidate ad link categories.

11. The method of claim 9, further comprising:
removing the selected ad link categories from the set of candidate ad link categories.

12. The method of claim 9, wherein:
the ad link categories in the set of candidate ad link categories are associated with a web page; and
the ad link categories in the set of candidate ad link categories are ordered by relevance of the ad link categories to the web page.

13. A method comprising:
for a set of candidate ad link categories and at least one ad link unit associated with a web page:
selecting a first ad link category for a first position of the ad link unit, the first ad link category being in the set of candidate ad link categories; and
for at least one empty position in the ad link unit:
identifying ad link categories having a similarity measure that is greater than a similarity threshold, the identified ad link categories being in the set of candidate ad link categories, at least one ad link category in the set of candidate ad link categories having one or more similarity measures associated with a most recently selected ad link category; and
selecting a next ad link category for a next empty position of the ad link unit, the next ad link category being in the set of candidate ad link categories.

14. The method of claim 13, further comprising:
removing the identified ad link categories from the set of candidate ad link categories before selecting a next ad link category for a next empty position of the ad link unit; and
adding at least one removed identified ad link category to the set of candidate ad link categories before selecting a first ad link category for a first position of a next ad link unit.

15. A system comprising:
a processor;
a computer-readable medium operatively coupled to the processor and having instructions stored thereon, which, when executed by the processor, causes the processor to perform operations comprising:
selecting a first ad link category for a first position of an ad link unit; and
identifying one or more second ad link categories using one or more similarity measures, at least one second ad link category having one or more similarity measures associated with the first ad link category.

16. The system of claim 15, where the processor performs operations comprising:
selecting a third ad link category for a second position of the ad link unit, where the third ad link category is different from the one or more identified second ad link categories.

17. The system of claim 15, wherein:
the ad link unit is associated with a web page; and
the ad link categories are ordered by relevance to the web page.

18. The system of claim 15, wherein identifying one or more second ad link categories using one or more similarity measures further comprises:
identifying one or more ad link categories having a similarity measure that is less than a similarity threshold.

19. The system of claim 18, wherein:
the ad link categories are associated with one or more vertical identifiers; and
at least one of the one or more similarity measures of a second ad link category is a measure of the similarity between a vertical identifier associated with the second ad link category and a vertical identifier associated with the first ad link category.

20. The system of claim 19, wherein at least one second ad link category has a separate similarity measure for at least one pair-wise combination of a vertical identifier associated with the at least one second ad link category and a vertical identifier associated with the first ad link category.

21. The system of claim 20, wherein the at least one second ad link category has a composite similarity measure, the composite similarity measure being one of a maximum, a minimum, or a combination of the separate similarity measures for the at least one second ad link category.

22. The system of claim 21, wherein identifying one or more ad link categories having a similarity measure that is less than a similarity threshold further comprises:
identifying one or more ad link categories having a composite similarity measure that is less than a similarity threshold.

23. A system comprising:
a processor;
a computer-readable medium operatively coupled to the processor and having instructions stored thereon, which, when executed by the processor, causes the processor to perform operations comprising:
selecting a first ad link category for a first position of an ad link unit, the first ad link category being in a set of candidate ad link categories; and
for at least one empty position in the ad link unit:
identifying ad link categories having a similarity measure that is less than a similarity threshold, the identified ad link categories being in the set of candidate ad link categories, at least one ad link category in the set of candidate ad link categories having one or more similarity measures associated with a most recently selected ad link category; and
selecting a next ad link category for a next empty position of the ad link unit, the next ad link category being in the set of candidate ad link categories.

24. The system of claim 23, where the processor performs operations comprising:
removing the identified ad link categories from the set of candidate ad link categories.

25. The system of claim 23, where the processor performs operations comprising:
removing the selected ad link categories from the set of candidate ad link categories.

26. The system of claim 23, wherein:
the ad link categories in the set of candidate ad link categories are associated with a web page; and
the ad link categories in the set of candidate ad link categories are ordered by relevance of the ad link categories to the web page.

27. A system comprising:
a processor;
a computer-readable medium operatively coupled to the processor and having instructions stored thereon, which, when executed by the processor, causes the processor to perform operations comprising:
for a set of candidate ad link categories and at least one ad link unit associated with a web page:
selecting a first ad link category for a first position of the ad link unit, the first ad link category being in the set of candidate ad link categories; and
for at least one empty position in the ad link unit:
identifying ad link categories having a similarity measure that is greater than a similarity threshold, the identified ad link categories being in the set of candidate ad link categories, at least one ad link category in the set of candidate ad link categories having one or more similarity measures associated with a most recently selected ad link category; and
selecting a next ad link category for a next empty position of the ad link unit, the next ad link category being in the set of candidate ad link categories.

28. The system of claim 27, where the processor performs operations comprising:
removing the identified ad link categories from the set of candidate ad link categories before selecting a next ad link category for a next empty position of the ad link unit; and
adding at least one removed identified ad link category to the set of candidate ad link categories before selecting a first ad link category for a first position of a next ad link unit.

29. A computer-readable medium having instructions stored thereon, which, when executed by a processor, causes the processor to perform operations comprising:
selecting a first ad link category for a first position of an ad link unit; and
identifying one or more second ad link categories using one or more similarity measures, at least one second ad link category having one or more similarity measures associated with the first ad link category.

30. The computer-readable medium of claim 29, further comprising:
selecting a third ad link category for a second position of the ad link unit, where the third ad link category is different from the one or more identified second ad link categories.

31. The computer-readable medium of claim 29, wherein:
the ad link unit is associated with a web page; and
the ad link categories are ordered by relevance to the web page.

32. The computer-readable medium of claim 29, wherein identifying one or more second ad link categories using one or more similarity measures further comprises:
identifying one or more ad link categories having a similarity measure that is less than a similarity threshold.

33. The computer-readable medium of claim 32, wherein:
the ad link categories are associated with one or more vertical identifiers; and
at least one of the one or more similarity measures of a second ad link category is a measure of the similarity between a vertical identifier associated with the second ad link category and a vertical identifier associated with the first ad link category.

34. The computer-readable medium of claim 33, wherein at least one second ad link category has a separate similarity measure for at least one pair-wise combination of a vertical identifier associated with the at least one second ad link category and a vertical identifier associated with the first ad link category.

35. The computer-readable medium of claim 34, wherein the at least one second ad link category has a composite similarity measure, the composite similarity measure being one of a maximum, a minimum, or a combination of the separate similarity measures for the at least one second ad link category.

36. The computer-readable medium of claim 35, wherein identifying one or more ad link categories having a similarity measure that is less than a similarity threshold further comprises:
identifying one or more ad link categories having a composite similarity measure that is less than a similarity threshold.

37. A computer-readable medium having instructions stored thereon, which, when executed by a processor, causes the processor to perform operations comprising:
selecting a first ad link category for a first position of an ad link unit, the first ad link category being in a set of candidate ad link categories; and
for at least one empty position in the ad link unit:
identifying ad link categories having a similarity measure that is less than a similarity threshold, the identified ad link categories being in the set of candidate ad link categories, at least one ad link category in the set of candidate ad link categories having one or more similarity measures associated with a most recently selected ad link category; and
selecting a next ad link category for a next empty position of the ad link unit, the next ad link category being in the set of candidate ad link categories.

38. The computer-readable medium of claim 37, further comprising:
removing the identified ad link categories from the set of candidate ad link categories.

39. The computer-readable medium of claim 37, further comprising:
removing the selected ad link categories from the set of candidate ad link categories.

40. The computer-readable medium of claim 37, wherein:
the ad link categories in the set of candidate ad link categories are associated with a web page; and
the ad link categories in the set of candidate ad link categories are ordered by relevance of the ad link categories to the web page.

41. A computer-readable medium having instructions stored thereon, which, when executed by a processor, causes the processor to perform operations comprising:
for a set of candidate ad link categories and at least one ad link unit associated with a web page:
selecting a first ad link category for a first position of the ad link unit, the first ad link category being in the set of candidate ad link categories; and
for at least one empty position in the ad link unit:
identifying ad link categories having a similarity measure that is greater than a similarity threshold, the identified ad link categories being in the set of candidate ad link categories, at least one ad link category in the set of candidate ad link categories having one or more similarity measures associated with a most recently selected ad link category; and
selecting a next ad link category for a next empty position of the ad link unit, the next ad link category being in the set of candidate ad link categories.

42. The computer-readable medium of claim 41, further comprising:
removing the identified ad link categories from the set of candidate ad link categories before selecting a next ad link category for a next empty position of the ad link unit; and
adding at least one removed identified ad link category to the set of candidate ad link categories before selecting a first ad link category for a first position of a next ad link unit.
